(19) United States
(12) Patent Application Publication
(10) Pub. No.: US 2008/0303860 A1
(43) Pub. Date: Dec. 11, 2008

(54) Liquid ejecting head and printing apparatus

(75) Inventors: Tatsumi Ito, Kanagawa (JP); Takeshi Matsui, Tokyo (JP); Yuichiro Ikemoto, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/156,914

(22) Filed: Jun. 5, 2008

(30) Foreign Application Priority Data
Jun. 7, 2007 (JP) JP2007-151839

(51) Int. Cl. B41J 2/165

(52) U.S. Cl. 347/34

(57) ABSTRACT

Disclosed is a liquid ejecting head includes a head main body having nozzles facing a spray surface of a rotating member rotationally driven, and ejecting liquid from the nozzles, and a mist capturing unit capturing mist of the liquid ejected from the nozzles. In the liquid ejecting head, the mist capturing unit is formed such that a passage, through which air flows in a predetermined direction over the spray surface while the rotating member is driven to rotate, is formed narrower than a distance between the nozzles and the spray surface.

### CROSS REFERENCES TO RELATED APPLICATIONS

The present invention contains subject matter related to Japanese Patent Application JP 2007-151839 filed in the Japanese Patent Office on Jun. 7, 2007, the entire contents of which being incorporated herein by reference.

### BACKGROUND OF THE INVENTION

1. Field of the Invention

The present invention relates to a liquid ejecting head for ejecting and adhering liquid, such as ink droplets or testing liquid, onto a predetermined surface (ink-ejected surface, ink-adhered surface, etc.) of a rotating member causing to be rotated, such as a disk-shaped recording medium and a semiconductor storage medium including a CD-R (compact disc-recordable) and a DVD-RW (digital versatile disc-rewritable), and also to a printing apparatus for printing visible information such as characters and pictures onto a printing surface utilizing the liquid ejecting head.

2. Description of the Related Art

In a related art ink-jet type printing apparatus, ink droplets each having a predetermined mass is ejected from respective nozzles to print visible information such as characters and pictures onto a printing surface.

However, when the ink droplets are ejected from the nozzles, mist (liquid droplets) particles of which each having a diameter smaller than a predetermined diameter are generated without having reached the printing surface, so that the mist is flowing in a space between a print head and the printing surface. The mist includes fine liquid particles (droplets) that are formed in a process where ink droplets each are split up to be deformed into a spherical shape due to surface tension after ejecting the ink droplets from nozzles, or the particles are generated by accidentally ejecting residual ink in a nozzle hole due to vibration subsequent to ejecting the ink droplets from the nozzles. When the mist is ejected from the nozzle, the mist, droplets of which each have a small diameter, loses speed due to air resistance and flows to ride in a peripheral air flow. Therefore, the mist will fly in all directions and adheres onto parts other than the printing subject in the printing apparatus, thereby contaminating the internal printing apparatus.

Japanese Unexamined Patent Application Publication No. 2006-248133, for example, discloses one technology to control such contamination. The disclosed document discloses a liquid ejecting apparatus which ejects liquid to an ejecting subject from nozzle openings formed in a liquid ejecting head. The liquid ejecting apparatus disclosed in Japanese Unexamined Patent Application Publication No. 2006-248133 “includes a liquid ejecting head for ejecting liquid from a nozzle surface and a carriage that includes the liquid ejecting head and that is reciprocated in a main scanning direction, in which the carriage or the liquid ejecting head includes an air flow control member located at both sides of the main scanning direction of the liquid ejecting head for controlling an air flow caused according to movement of the carriage so as to flow toward an ejecting surface”.

The liquid ejecting apparatus having the above configuration is expected to provide such an effect that “the inside of the apparatus can be prevented from being contaminated by atomized liquid droplets”.

However, in the liquid ejecting apparatus as disclosed in Japanese Unexamined Patent Application Publication No. 2006-248133, the air flow caused by movement of the carriage flows to an ejecting surface due to presence of an air flow control member, and then flows through a space between the air flow control member and the ejecting surface towards a rear portion of the carriage. Therefore, part of the mist is not adhered to the ejecting surface but flies in all directions to be carried by the air flow from a lower part of the air flow control member to the outside of the carriage. As a result thereof, the ink mist generated upon printing may not be effectively captured, and hence the mist contaminates a peripheral portion of the carriage.

Further, in a case where the liquid ejecting apparatus as described above is mounted on an optical disk device to print visible information such as characters and pictures onto a labeling surface of an optical disk, the mist may adhere to a movable portion, a lens, or the like of the optical pickup to contaminate the same. Especially, the pickup lens of the optical pickup is exposed so as to face an information recording surface of the optical disk and thus has a positional relation that the pickup lens faces nozzles of the print head with the optical disk interposed therebetween, so that the mist tends to adhere to the pickup lens. As a result thereof, if the mist adheres to the pickup lens to contaminate the pickup lens by a printing ink, reading and writing of information signals will be difficult, resulting in deterioration in recording (writing) and reproduction (reading) performance.

### SUMMARY OF THE INVENTION

A liquid ejecting head may not be effectively capture liquid mist generated at ejecting liquid, peripheral portions thereof are contaminated by the flowing mist. As a result thereof, for example, if the mist adheres to a movable portion or an optical system of the optical pickup to contaminate the same, reading and writing of an information signals will be difficult, thereby resulting in deterioration in recording and reproducing performance of the printing apparatus.

A liquid ejecting head according to an embodiment of the present invention includes a head main body having nozzles facing a spray surface of a rotating member rotationally driven, and ejecting liquid from the nozzles, and a mist capturing unit capturing mist of the liquid ejected from the nozzles. In the liquid ejecting head of the embodiment, the mist capturing unit is formed such that a passage, through which air flows in a predetermined direction over the spray surface while the rotating member is driven to rotate, is formed narrower than a distance between the nozzles and the spray surface.

A printing apparatus according to an embodiment of the present invention includes a print head for printing visible information by ejecting ink droplets onto a printing surface of a printing subject rotationally driven by a rotation drive unit. In the printing apparatus of the embodiment, the liquid ejecting head includes a head main body having nozzles facing the printing surface, and ejecting the ink droplets from the nozzles, and a mist capturing unit capturing mist of the ink droplets from the nozzles, where the mist capturing unit is formed such that a passage, through which air flows in a predetermined direction over the printing surface while the printing subject is driven to rotate, is formed narrower than a distance between the nozzles and the printing surface.

Since the passage is made narrow through which air flows while the rotating member is rotationally driven, the probability of the flowing mist that would contact the passage would increase. As a result, the liquid ejecting head and the printing apparatus according to the embodiment of the present invention can capture the mist effectively. Thus, peripheral devices are prevented from being contaminated by the flowing mist. For example, in the liquid ejecting head and the printing apparatus according to the embodiment of the present invention, the movable portions, the lens, or the like of the optical pickup can be prevented from being contaminated due to adhesion of the mist, thereby preventing the performance in recording and reproducing information signals from deterioration.

### BRIEF DESCRIPTION OF THE DRAWINGS

FIG. 1 is a block diagram illustrating an optical disk device of a printing apparatus according to a first embodiment of the present invention.

FIG. 2 is a perspective view illustrating a print head of a liquid ejecting head according to the first embodiment of the present invention.

FIG. 3 is a cross sectional view of the print head of the liquid ejecting head according to the first embodiment of the present invention.

FIG. 4 is a perspective view illustrating a print head of the liquid ejecting head according to a second embodiment of the present invention.

FIG. 5 is a cross sectional view illustrating the print head of the liquid ejecting head according to the second embodiment of the present invention.

FIG. 6 is a perspective view illustrating a modification of the print head of the liquid ejecting head according to the second embodiment of the present invention.

FIG. 7 is a perspective view illustrating a print head of the liquid ejecting head according to a third embodiment of the present invention.

FIG. 8 is a cross sectional view illustrating the print head of the liquid ejecting head according to the third embodiment of the present invention.

FIG. 9 is a cross sectional view illustrating a print head of the liquid ejecting head according to a fourth embodiment of the present invention.

FIG. 10 is a cross sectional view illustrating a print head of the liquid ejecting head according to a fifth embodiment of the present invention.

FIG. 11 is a cross sectional view illustrating the print head of the liquid ejecting head according to a sixth embodiment of the present invention.

FIG. 12 is a cross sectional view illustrating a print head of the liquid ejecting head according to a seventh embodiment of the present invention.

FIG. 13A is a cross sectional view illustrating a print head of the liquid ejecting head according to an eighth embodiment of the present invention; FIG. 13B is a cross sectional view of the print head of the liquid ejecting head according to a ninth embodiment of the present invention; and FIG. 13C is a cross sectional view of a print head of the liquid ejecting head according to a tenth embodiment of the present invention.

### DESCRIPTION OF THE PREFERRED EMBODIMENTS

A mist capturing unit according to an embodiment of the present invention includes a passage that is made narrower through which air flows. Accordingly, liquid mist generated when ejecting liquid from nozzles can be captured effectively due to an increased probability in the mist that would contact the passage, so that peripheral devices, parts, and the like are prevented from being contaminated by the liquid mist. Accordingly, the liquid ejecting head and the printing apparatus having a simple configuration can be realized that, for example, adhesion of the mist onto movable portions, a lens, or the like of an optical pickup may be prevented to thereby suppress the performance in recording and reproducing information signals.

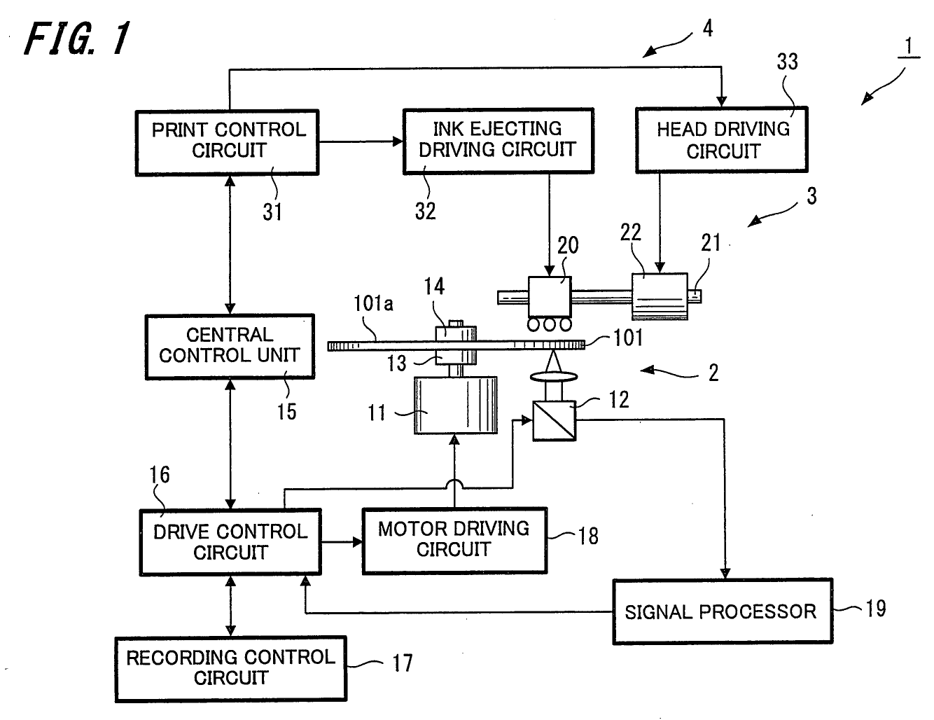

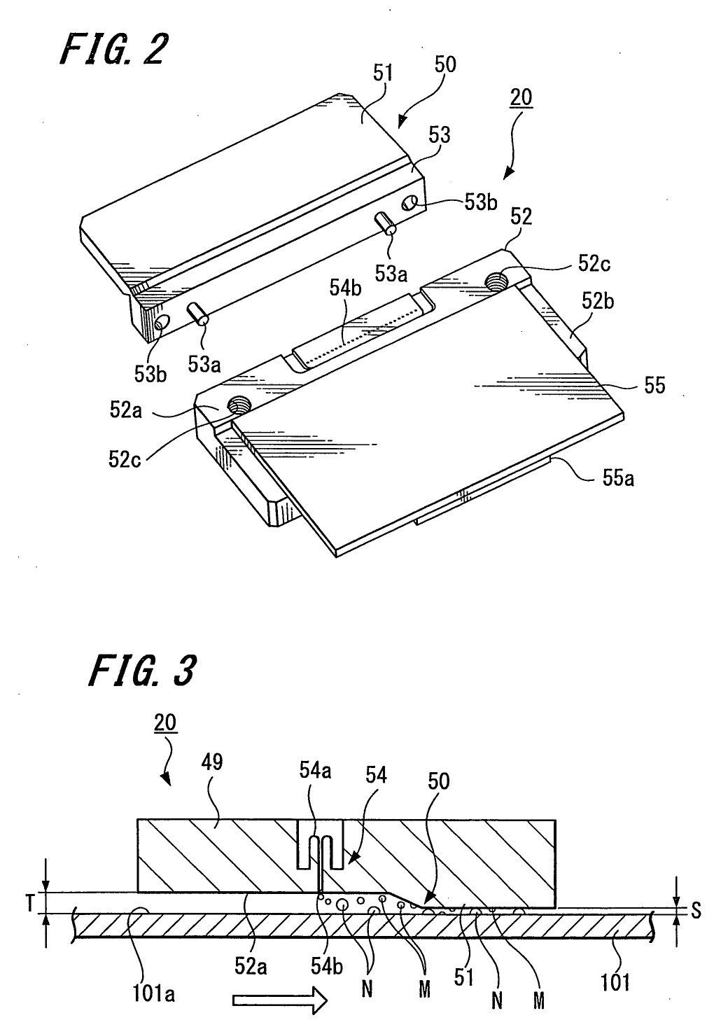

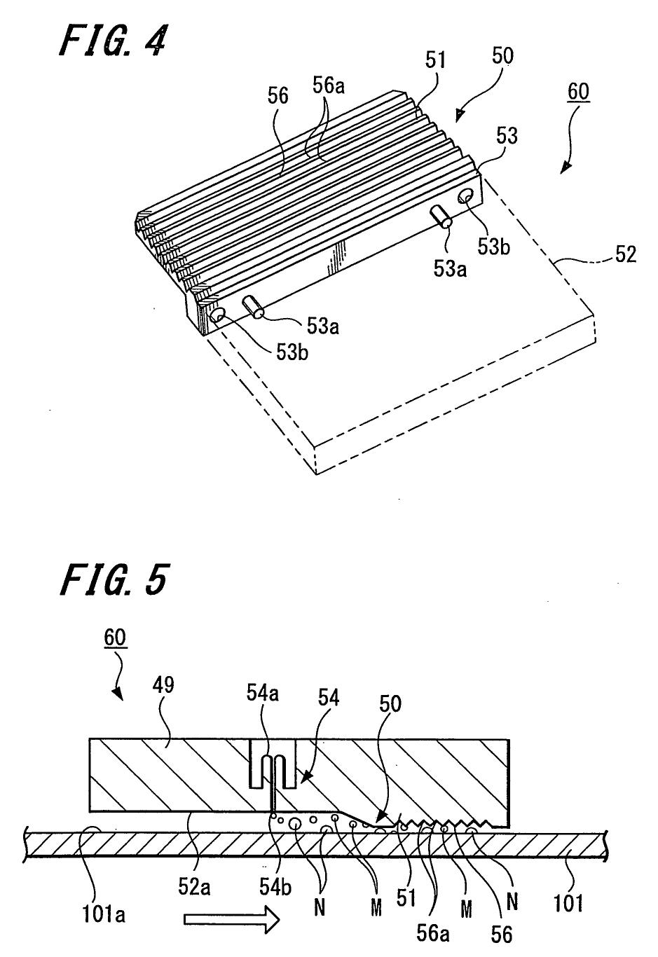

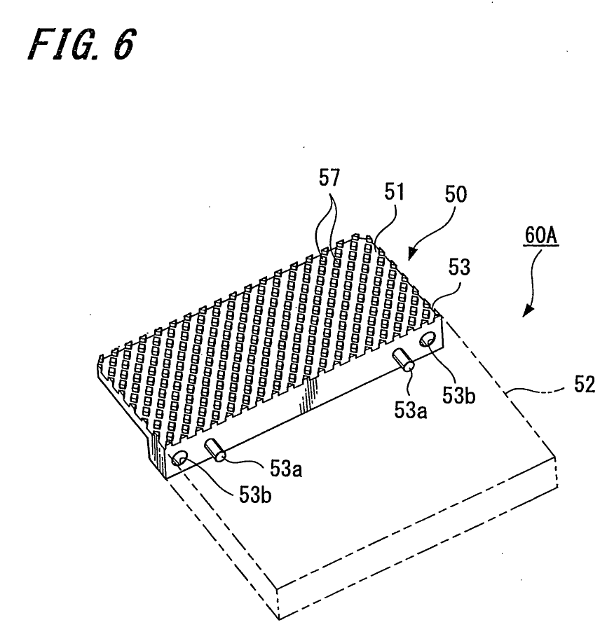

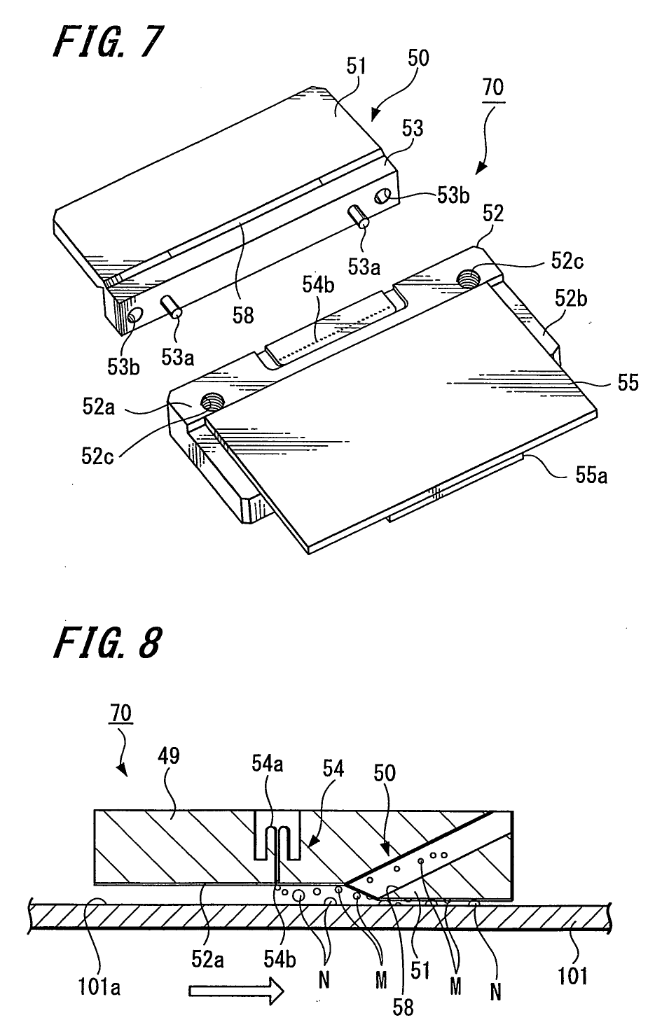

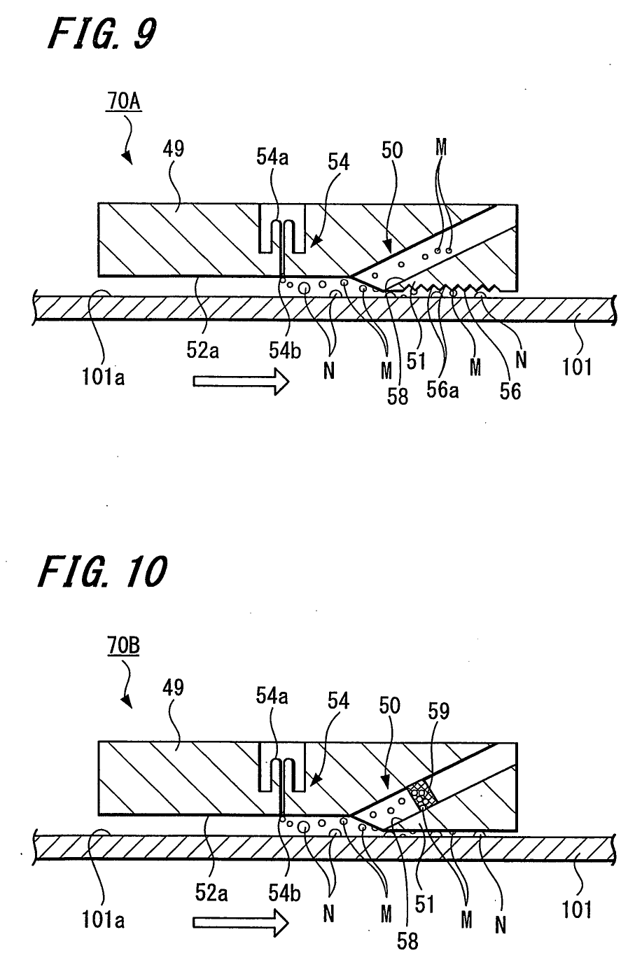

Embodiments of the present invention will be described below with reference to the accompanying drawings. FIGS. 1 to 13 illustrate the embodiments of the present invention. More specifically, FIG. 1 illustrates a printing apparatus of the first embodiment of the present invention; FIGS. 2 and 3 each illustrate a liquid ejecting head of the first embodiment of the present invention; FIGS. 4 and 5 each illustrate a second embodiment of the liquid ejecting head of the present invention; FIG. 6 illustrates a modification of the liquid ejecting head according to the second embodiment of the present invention; FIGS. 7 and 8 each illustrate a third embodiment of the liquid ejecting head of the present invention; FIGS. 9 to 13 each illustrate other modifications of the liquid ejecting head according to other embodiments of the present invention.

FIG. 1 illustrates an optical disk device 1 employed as a printing apparatus according to the first embodiment of the present invention. The optical disk device 1 can record (write) a new information signal on and reproduce (read) the information signal stored in the optical disk 101 from an information recording surface of an optical disk 101 showing as one specific example of a printing subject, such as a CD-R (compact disc-recordable), a DVD-RW (digital versatile disc-rewritable), or the like. Also, the optical disk device 1 can print visible information such as characters, pictures, and the like, onto a labeling surface 101a showing as one example of a printing surface located opposite side of the information recording surface of the optical disk 101. As shown in FIG. 1, the optical disk device 1 includes a disk drive device 2, a printing unit 3, a print control unit 4, and the like.

The disk drive device 2 includes a spindle motor 11 showing as one example of the rotation drive unit causing the optical disk 101 to rotate, and an optical pickup 12 and the like writing/reading information onto/from the information recording surface of the optical disk 101 rotated by the spindle motor 11.

A turn table 13 is provided on a leading end of a rotation shaft of the spindle motor 11. The turn table 13 has a disk fitting portion detachably fitted with a central hole of the optical disk 101. A chucking plate 14 is provided above the spindle motor 11 to depress the optical disk 101 placed on the turn table 13 from above. The chucking plate 14 is rotationally supported by a supporting plate (not shown) and rotates integrally with the optical disk 101.

The central hole of the optical disk 101 is fitted with the disk fitting portion and the chucking plate 14 is placed thereon, so that the optical disk 101 can integrally rotated with the turn table 13. As described above, after the optical disk 101 is sandwiched between the chucking plate 14 and the turn table 13, the spindle motor 11 is rotationally driven to cause the optical disk 101 to rotate integrally with the turn table 13 at a constant linear speed.

The optical pickup 12 includes, for example, a light source, a light detector, a pickup lens, a biaxial actuator causing the pickup lens to face an information recording surface of the optical disk 101 (a counter surface of the labeling surface 101a), and the like. In the optical pickup 12, a light beam emitted from a light source and converged by the pickup lens, so that the information recording surface of the light disk 101 is irradiated with the converged light beam, while the light detector receives the return light beam reflected by the information recording surface. Accordingly, the light pickup 12 can record (write) the information signal onto the information recording surface and reproduce (read) the information signal recorded on the information recording surface.

The optical pickup 12 is mounted on a pickup base, not shown, and is moved integrally with the pickup base. The pickup base is movable in a radial direction of the optical disk 101 utilizing a pickup movement mechanism having a pickup motor, not shown.

An example of the pickup movement mechanism for moving the pickup base includes a feed screw mechanism. However, the pickup movement mechanism is not limited to the feed screw mechanism but may be other mechanisms, such as a rack-and-pinion mechanism, a belt feed mechanism, and a wire feed mechanism.

The disk drive device 2 includes a central control unit 15 controlling operations of the spindle motor 11 and the optical pickup 12, a drive control circuit 16, a recording control circuit 17, a motor driving circuit 18, a signal processor 19, and the like.

The central control unit 15 outputs a recorded data signal to the drive control circuit 16 and outputs an image data signal to the print control unit 4. The central control unit 15 also outputs a positional data signal indicating positional information retrieved from the optical disk 101 supplied from the drive control circuit 16 to the print control unit 4.

The drive control circuit 16 outputs a control signal to the motor driving circuit 18 and controls the rotation of a pickup drive motor. Also, the drive control circuit 16 outputs a control signal to the optical pickup 12 and controls a track servo and a focus servo, so that the light beam emitted from the pickup lens of the optical pickup 12 can trace a track provided on the information recording surface of the optical disk 101. Further, the drive control circuit 16 outputs a positional data signal supplied from the signal processor 19 to the central control unit 15.

The recording control circuit 17 performs processing such as encode processing or modulation on the reproduction data signal supplied from the drive control circuit 16 and outputs the reproduction data signal to the drive control circuit 16. The motor driving circuit 18 drives the spindle motor 11 based on the control signal supplied from the drive control circuit 16. Accordingly, the optical disk 101 placed on the turn table 13 of the spindle motor 11 is rotated. Also, the motor driving circuit 18 drives the pickup driving motor based on the control signal obtained from the drive control circuit 16. Accordingly, the optical pickup 12 is moved in a radial direction of the optical disk 101 integrally with the pickup base.

The signal processor 19 generates a reproduction data signal by performing demodulation, error detection, and the like on the RF (radio frequency) signal supplied from the optical pickup 12. Also, the signal processor 19 detects a positional data signal as a signal representing a signal having a specified pattern such as a synchronizing signal based on the RF signal or a signal representing positional information of the optical disk 101. The signal processor 19 outputs the reproduction data signal and the positional data signal to the drive control circuit 16.

The printing unit 3 includes a print head 20 for ejecting ink droplets onto a labeling surface 101a of the optical disk 101 while being rotated, a head driving mechanism moving the print head 20 in a predetermined direction, and the like.

The print head 20 is placed facing the labeling surface 101a of the optical disk 101. The print head 20 includes a head main body having nozzles facing the labeling surface 101a and the like. The print head 20 will be described later in detail.

The head driving mechanism includes a sliding member, not shown, for supporting the print head 20; a guide shaft 21 for supporting the sliding member in a slidable manner; a head driving motor 22; or the like. The guide shaft 21 extends, for example, in the radial direction of the optical disk 101, both ends of which are fixed to a guide shaft support unit in the shaft direction. Also, examples of the head driving mechanism include, as similar to those of the pickup movement mechanism, a feed screw mechanism, a rack-and-pinion mechanism, a belt feed mechanism, a wire feed mechanism, or the like. By utilizing the head driving mechanism, the print head 20 is movable in a predetermined direction along the guide shaft 21, for example, in a radial direction of the optical disk 101.

The print control unit 4 includes a print control circuit 31 for controlling drives of the print head 20, the head driving mechanism, or the like; an ink ejecting driving circuit 32; a head driving circuit 33; and the like.

The print control circuit 31 generates an ink ejecting data based on an image data signal supplied from the central control unit 15. The print control circuit 31 generates a control signal for controlling the print head 20 and the head driving motor 22 based on the thus generated ink ejecting data and the positional data signal supplied from the central control unit 15 and outputs the control signal to the ink ejecting driving circuit 32 and the head driving circuit 33.

The ink ejecting driving circuit 32 drives the print head 20 based on the control signal supplied from the print control circuit 31. Accordingly, the ink droplets are ejected from the nozzles of the print head 20 and dropped onto the labeling surface 101a of the optical disk 101 while the optical disk 101 is rotated. Also, the head driving circuit 33 drives the head driving motor 22 based on the control signal supplied from the print control circuit 31. The print head 20 is moved in a predetermined direction, for example, in a radial direction of the optical disk 101 according to the drive of the head driving motor 22.

Next, the print head of the liquid ejecting head according to the first embodiment of the present invention will be described below with reference to FIGS. 2 and 3. The print head 20 shown in FIGS. 2 and 3 includes a head main body 49 having a substantially rectangular parallelepiped to which a mist capturing unit 50 is provided. The head main body 49 includes a first member 52, a second member 53 secured on the first member 52 with one surface of the second member 53 contacting the first member 52, or the like. In the present embodiment, the head main body 49 including two members such as the first member 52 and the second member 53 is described; however, the head main body 49 is not limited thereto. The head main body 49 may include, for example, one member or a combination of three or more members.

The first member 52 is formed in a substantially rectangular parallelepiped. The first member 52 includes a head surface 52a facing the labeling surface 101a indicating one example of the spayed surface of the optical disk 101 indicating one example of the rotating member; a plurality of nozzles 54 provided in the head surface 52a; a board mounting surface 52b on which a wiring board 55 is mounted; and the like. Screw holes 52c, 52c are provided at both end portions of the first member 52 in a width direction. The sliding member is fastened by placing fixation screws in the screw holes 52c, 52c.

The nozzles 54 each include a connecting portion 54a having openings in one surface, and a plurality of ejecting ports 54b communicated with the connecting portion 54a and having multiple branches to form multiple openings in the other surface thereof. The number of nozzles 54 provided is equal to the number of inks to be used, and ink droplets N of a predetermined color are ejected through the nozzles 54. For example, in the case of multi-color printing using four ink cartridges of, for example, cyan (c), magenta (M), yellow (Y), and black (K), there are provided four nozzles 54 for cyan, magenta, yellow, and black.

The connecting portion 54a of each of the nozzles 54 is connected to an ink cartridge, not shown, for a predetermined color through a connection pipe. The plurality of ejecting ports 54b is formed with the openings in the head surface 52a that faces the labeling surface 101a. The plurality of ejecting ports 54b is provided, for example, in the head surface 52a in one or more rows along a direction intersected with a rotational direction of the optical disk 101.

The board mounting surface 52b has a step surface that is recessed by a thickness of the wiring board 55 measured from the head surface 52a. The board mounting surface 52b includes the wiring board 55 using a fixing agent such as an adhesive. The wiring board 55 includes a wiring circuit and a connector 55a. The connector 55a is connected to a terminal strip of the ink ejecting driving circuit 32 and thereby the wiring circuit of the wiring board 55 is electrically connected to the ink ejecting driving circuit 32.

The second member 53 is formed in a substantially rectangular parallelepiped. The second member 53 includes a mist capturing unit 50 and connection pins 53a.

The connection pins 53a are provided on both ends, one for each end, of a surface where the second member 53 and the first member 52 are mutually in contact in a width direction so as to project in the same direction. The connection pins 53a are inserted into connection holes, not-shown, provided in the first member 52. The screw holes 53b, 53b are provided in the vicinity of the connection pins 53a. The fixation screws are threadably inserted in the screw holes 53b, 53b to integrally fix the first member 52 with the second member 53.

The mist capturing unit 50 is an extending portion 51 extending to a side of the labeling surface 101 of the optical disk 101 from the head surface 52a in a state where the first member 52 and the second member 53 are integrally fixed each other. As shown in FIG. 3, in the mist capturing unit 50, a distance S between the optical disk 101 and the extending portion 51 is shorter than a distance T between the optical disk 101 and the ejecting ports 54b (head surface 52a) of the nozzles 54 (S<T) when the print head 20 faces the optical disk 101. Thus, a passage of air formed narrower than the space between the ejecting ports 54b and the optical disk 51 is formed between a leading end surface of the extending portion 51 and the optical disk 101.

The extending portion 51 as the mist capturing unit 50 is positioned in the vicinity of a side of the ejecting ports 54b of the nozzles 54 while the first member 52 and the second member 53 are integrally fixed with each other. The mist capturing unit 50 is positioned at a forward side of the optical disk 101 from the ejecting ports 54b in the rotational direction when the print head 20 is positioned facing the optical disk 101. Further, the step surface of the extending portion 51 is continuously formed with the head surface 52a to have an obtuse angle therewith. Therefore, the air flowing while the optical disk 101 is driven to rotate flows through the space between the leading end surface of the extending portion 51 and the optical disk 101 along a slope of the step surface.

The print head 20 has a blade, not shown, for example, made of rubber. The blade contacts the ejecting ports 54b of the nozzles 54 and the extending portion 51 utilized as the mist capturing unit 50 to remove foreign particles such as dust and dirt, and ink adhered to the surfaces thereof while the print head 20 is not operated. Further, a sponge roller is allowed to contact with the ejecting ports 54b and the extending portion 51 utilized as the mist capturing unit 50 and to rotate thereon instead of the blade, thereby causing the sponge roller to adsorb the foreign particles such as the dust and the dirt, and the ink.

Subsequently, how the print head 20 having the above-described configuration operates will now be described. Initially, the optical disk 101 is placed on the turn table 13. Then, as shown in FIG. 3, the head driving motor 22 is driven to cause the print head 20 to move along the guide shaft 21, so that the ejecting ports 54b of the nozzles 54 of the print head 20 face the labeling surface 101a.

In the above-described state, the spindle motor 11 is driven to rotate the optical disk 101 and the print head 20 is also driven by the ink ejecting driving circuit 32. Visible information such as characters and pictures is printed onto the labeling surface 101a of the optical disk 101 by ejecting ink droplets N from the ejecting ports 54b onto the labeling surface 101a of the optical disk 101. Accordingly, desirable visible information such as character information such as a title of music and a name of a singer, a title of a movie, or a picture of an impressive scene can be printed onto the labeling surface 101a of the optical disk 101 while the optical disk 101 is rotating.

At this time, in the ink ejecting type print head 20 having the above-described configuration, unnecessary mist M is generated by ejecting the ink droplets N from the nozzles 54 to flow the mist M in air. When the optical disk 101 is driven to rotate, the mist M rides on an air flow and move in the rotational direction of the optical disk 101.

In the present embodiment, the mist capturing unit 50 is provided at the forward side in the rotational direction of the optical disk 101. Thus, the mist M migrates by riding on the air flow and is captured by the mist capturing unit 50 positioned in a moving direction of the air flow.

The mist M having migrated to the mist capturing unit 50 partially adheres to the step surface of the extending portion 51 and the residual mist M flows into the space between the leading end surface of the extending portion 51 and the optical disk 101 along the slope of the step surface. Here, since the distance S between the extending portion 51 and the optical disk 101 is shorter than the distance T between the optical disk 101 and the ejecting ports 54b, the passage of air flow naturally becomes narrower. As described above, since the passage of the air flow is narrower, the mist M would more frequently contact with the extending portion 51 and the optical disk 101. Thus, since the mist M is likely to be adhered to the extending portion 51, the flowing mist M can effectively be captured and can be prevented from adhering to and contaminating the pickup lens or the other components of the optical pickup 12.

FIGS. 4 and 5 each illustrate a liquid ejecting head according to a second embodiment of the present invention. The print head 60 illustrated as the second embodiment is different from the print head 20 according to the first embodiment in that the extending portion 51 utilized as the mist capturing unit 50 includes an elongate groove portion 56. The elongate groove portion 56 is arranged such that a plurality of elongate grooves 56a, which extend in a row in a direction intersected with the rotational direction of the optical disk 101, is provided on a leading end surface of the extending portion 51 in this orthogonal direction. Other configurations of the print head 60 are the same as that of the print head 20 according to the first embodiment, so that descriptions thereof will be omitted. The print head 60 having the above-described configuration can also produce an effect similar to that produced by the print head 20 according to the above-described first embodiment.

The print head 60 according to the second embodiment includes the elongate groove portion 56 on the extending portion 51. The elongate groove portion 56 can more significantly disrupt the air flowing through the space between the extending portion 51 and the optical disk 101. Further, the elongate groove portion 56 facilitates enlarging the surface area and the capturing area for capturing the mist M. Therefore, the print head 60 according to the second embodiment causes the flowing mist M to adhere onto the surface of the extending portion 51 to securely and efficiently capture the mist M in comparison to the print head 20 according to the first embodiment.

Although the second embodiment is described by the example of the extending portion 51 having the plurality of queues of the elongate grooves 56a, it is not limited thereto. For example, only one elongate groove 56a may be provided on the extending portion 51. Alternatively, a projection may be provided on the extending portion 51 in a direction intersected with the rotational direction of the optical disk 101 instead of the elongate grooves 56a, and one or more projections may be provided in the orthogonal direction. Further, although the second embodiment is described by the example where projections or the elongate grooves are provided extending in a direction intersected with a certain radial direction, the projections and the elongate grooves may extend in the direction intersected with the certain radial direction with having a suitable angle to the certain radial direction.

Also, as in a case similar to a print head 60A as shown in FIG. 6, a plurality of projections 57 may be arranged on the extending portion 51 in staggered alignment. The print head 60A having the above-described configuration can also exhibit an effect similar to that obtained by the print head 60 according to the above-described second embodiment. Further, the embodiment of FIG. 6 illustrates an example in which the plurality of projections 57 are, for example, aligned in a staggered line, however, a plurality of recesses is provided in the extending portion 51, or the plurality of projections or the recesses may arbitrarily be arranged therein.

FIGS. 7 and 8 each illustrate a liquid ejecting head according to a third embodiment of the present invention. A print head 70 illustrated as the third embodiment is different from the print head 20 according to the first embodiment in that the extending portion 51 utilized as the mist capturing unit 50 includes a capturing hole 58 through which air passes. The capturing hole 58 is provided in the step surface of the extending portion 51 to have an opening. The capturing hole 58 is an elongated hole, and a width of the opening of the capturing hole 58 in the step surface of the extending portion 51 is formed slightly longer than a length of a line of the ejecting ports 54b provided in the head surface 52a. The capturing hole 58 in the step surface of the extending portion 51 is formed with an inclination having a suitable angle to the labeling surface 101a of the optical disk 101. The mist M is adhered on a side wall formed by the capturing hole 58 formed in the step surface of the extending portion 51, thereby capturing the mist M. Accordingly, the mist M flowing in air can efficiently and securely be captured in this embodiment in comparison to the print head 20 according to the first embodiment.

Other configurations of the liquid ejecting head according to the third embodiment are similar to those of the print head 20 according to the above-described first embodiment, so that explanations thereof will be omitted. The print head 70 having the above-described configuration will also exhibit an effect similar to that obtained by the print head 20 according to the first embodiment. In the present embodiment, although the capturing hole 58 is described as an elongated hole, the shape of the hole is not limited thereto. The capturing hole 58 may be one or more circular holes or a rectangular hole.

FIG. 9 illustrates a liquid ejecting head according to a fourth embodiment of the present invention. The print head 70A illustrated as the fourth embodiment is a combination of the mist capturing unit according to the second embodiment and the mist capturing unit according to the third embodiment. In other words, the print head 70A according to the fourth embodiment includes the elongate groove portion 56 in a leading end surface of the extending portion 51 and the capturing hole 58 in the step surface of the extending portion 51. Other configurations of the print head 70A according to the fourth embodiment are similar to those of the print head 20 according to the first embodiment, so that descriptions thereof will be omitted. The print head 70A having the above-described configuration also can exhibit an effect similar to that obtained by the print head 20 according to the above-described first embodiment.

FIG. 10 illustrates a liquid ejecting head according to a fifth embodiment of the present invention. The print head 70B illustrated as the fifth embodiment includes a filter 59 located in the capturing hole 58 for adsorbing the mist M according to the above-described third embodiment. By providing the filter 59 in the capturing hole of the print head 70B, adsorbing efficiency of the mist M can be increased, and thus the mist M can securely be captured. In addition, the capturing efficiency can constantly be held at a high level by replacing the filter 59.

Other configurations of the print head 70B according to the fifth embodiment are similar to those of the print head 20 according to the first embodiment, so that descriptions thereof will be omitted. The print head 70B having the above-described configuration also can exhibit an effect similar to that obtained by the print head 20 according to the first embodiment. Although the fifth embodiment is described by an example in which the print head includes the filters 59 for adsorbing the mist M in capturing hole 58 provided with the print head 70B, it is not limited thereto. For example, the projections or the recesses may be provided on the side wall of the capturing hole 58 of the print head 70B to disrupt the air flowing through the capturing hole 58, thereby efficiently capturing the mist M being adhered on the side wall formed by the capturing hole 58 in the print head 70B.

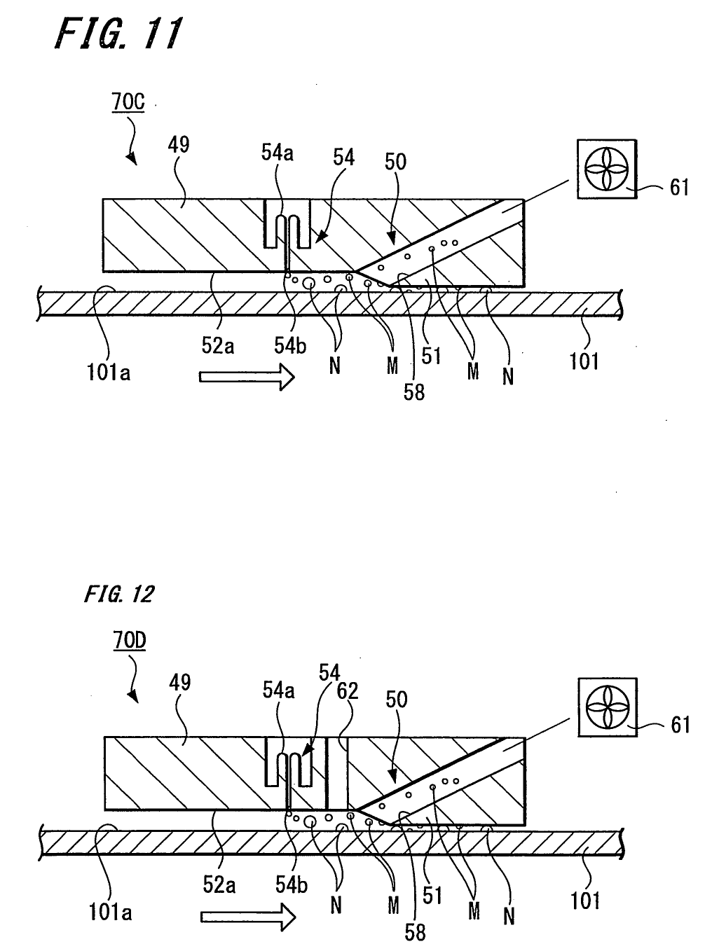

Further, the print head 70C may include a suctioning unit such as a fan 61 in the capturing hole 58 for suctioning air between the head main body 49 and the optical disk 101 in a similar manner as the print head 70C according to the sixth embodiment of FIG. 11. Accordingly, the mist M of the ink droplets N ejected from the ejecting ports 54b are suctioned by the suctioning unit. Thus, the mist M can more efficiently be captured.

In this case, when a large amount of air around a side of the ejecting ports 54b of the nozzles 54 is suctioned by the suctioning unit, the air immediately beneath the ejecting ports 54b may also be suctioned, so that the air immediately beneath the ejecting ports 54b may be disrupted to thereby cause displacement in the positions of the ink droplets N. Accordingly, the configuration as illustrated in the seventh embodiment of FIG. 11 may be employed for eliminating the cause of the displacement of the ink droplets positions as described above. A print head 70D according to the seventh embodiment includes an air introduction hole 62 provided between the capturing hole 58 and the ejecting ports 54b, so that the air passes through the head main body 49 in a vertical direction. The Air is supplied from the air introduction hole 62 to the side of the ejecting ports 54b of the head main body 49. Therefore, the thus supplied air functions as an air curtain between the ejecting ports 54b and the capturing hole 58, thereby preventing the air immediately beneath the ejecting ports 54b from being suctioned. Accordingly, the air immediately beneath the ejecting ports 54b is prevented from being disrupted, and thus the ink droplets N can be ejected at precise positions.

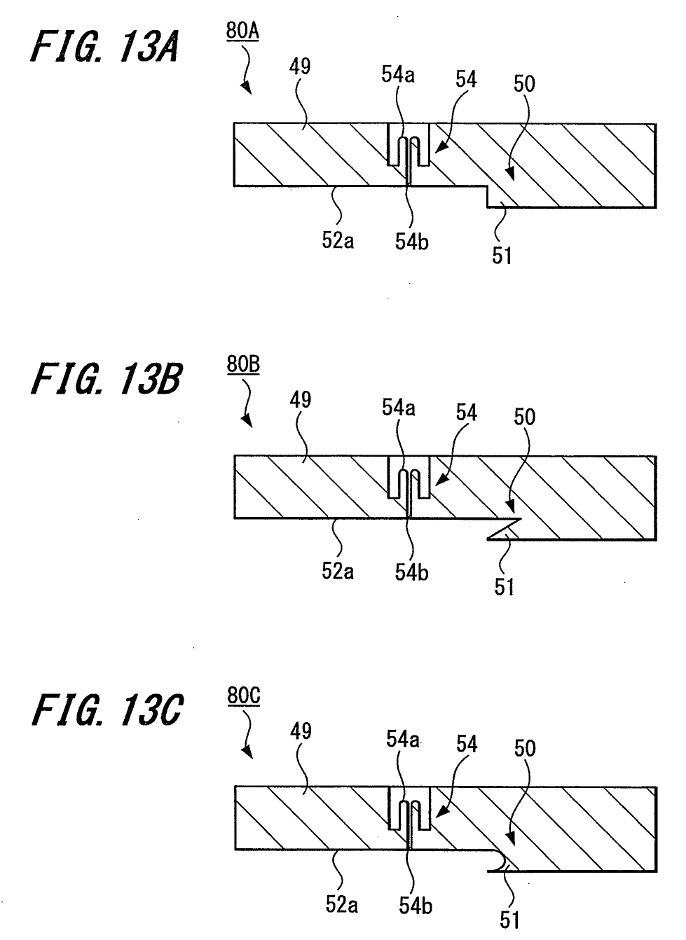

FIG. 13A illustrates a liquid ejecting head according to an eighth embodiment of the present invention. A print head 80A illustrated as the eighth embodiment differs from the print head 20 according to the first embodiment in that the step surface of the extending portion 51 forms substantially a right angle to the head surface 52a. Other configurations are similar to those of the print head 20 according to the first embodiment, so that descriptions thereof will be omitted. The print head 80A having the above-described configuration can also exhibit an effect similar to that obtained by the print head 20 according to the above-described first embodiment. According to the present embodiment, the air flowing while the optical disk 101 is driven to rotate can be more significantly disrupted by the step surface of the extending portion 51 in comparison to a case utilizing the print head 20 according to the first embodiment.

FIG. 13B illustrates a liquid ejecting head according to a ninth embodiment of the present invention. A print head 80B illustrated as the ninth embodiment differs from the print head 20 according to the first embodiment in that the step surface of the extending portion 51 is formed into an acute angle to the head surface 52a. Other configurations are similar to those of the print head 20 according to the first embodiment, so that descriptions thereof will be omitted. The print head 80B having the above-described configuration also can exhibit an effect similar to that obtained by the print head 20 according to the above-described first embodiment. According to the present embodiment, the air flow flowing while the optical disk 101 is driven to rotate can be more significantly disrupted by the step surface of the extending portion 51 in comparison to a case utilizing the print head 20 according to the first embodiment.

FIG. 13C is a liquid ejecting head according to a tenth embodiment of the present invention. A print head 80C illustrated as the tenth embodiment differs from the print head 20 according to the first embodiment in that the step surface of the extending portion 51 is formed into an arc shape from the head surface 52a of the step surface of the extending portion 51. Other configurations are similar to those of the print head 20 according to the first embodiment, so that descriptions thereof will be omitted. The print head 80C having the above-described configuration also can exhibit an effect similar to that obtained by the print head 20 according to the above-described first embodiment. According to the present embodiment, the air flow flowing while the optical disk 101 is driven to rotate can be more significantly disrupted by the step surface of the extending portion 51 in comparison to a case utilizing the print head 20 according to the first embodiment.

The liquid ejecting head according to the embodiment of the present invention is not limited to the print head 20 for ejecting the ink droplets N, but may be employed for various liquid ejecting heads such as a bioorganic substance ejecting head for ejecting a bioorganic substance to be used in biochip fabrication (e.g., deoxyribonucleic acid (DNA)), a sample ejecting head as a precision pipette, and the like.

As described above, in the liquid ejecting head and the printing apparatus according to the embodiment of the present invention, the mist capturing unit is formed such that the passage through which air flows while the optical disk is driven to rotate forms narrower. Therefore, the mist tends to contact the passage (extending portion) more frequently, and thus the mist flowing in the air can adhere effectively on the surface of the extending portion of the mist capturing unit. Accordingly, the capturing device can securely capture the mist flowing in the air to thereby prevent the peripheral devices from being contaminated by the mist.

The present invention is not limited to the above-described embodiments or the drawings, but can be modified without departing from the spirit of the invention. For example, although the above-described embodiments are described by using the optical disk such as the CD-R and the DVD-RW as the printing subject, the present invention is also employed for a printing apparatus having a printing subject with other recording system using an optical magnetic disk, a magnetic disk, and the like. Further, the printing apparatus according to the embodiments of the present invention is applied but not limited to the above-described optical disk device, and may also be used for other electronic devices utilizing this kind of printing apparatus such as an imaging device, a personal computer, an electronic dictionary, a DVD player, and a car navigation system.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid ejecting head comprising:
a head main body having nozzles facing a spray surface of a rotating member rotationally driven, and ejecting liquid from the nozzles; and
a mist capturing unit capturing mist of the liquid ejected from the nozzles, wherein
the mist capturing unit is formed such that a passage, through which air flows in a predetermined direction over the spray surface while the rotating member is driven to rotate, is formed narrower than a distance between the nozzles and the spray surface.

2. A liquid ejecting head according to claim 1, wherein
the mist capturing unit is provided on the surface facing the spray surface of the head main body, and includes an extending portion extending to a side of the spray surface.

3. A liquid ejecting head according to claim 2, wherein
the extending portion includes one or more elongate grooves, or projections extending in a direction intersected with a rotational direction of the rotating member.

4. A liquid ejecting head according to claim 2, wherein
the extending portion includes a plurality of projections or recesses aligned or arbitrarily arranged therein.

5. A liquid ejecting head according to claim 1, wherein
the mist capturing unit includes a capturing hole provided in the head main body to allow the air to pass through the capturing hole.

6. A liquid ejecting head according to claim 5, wherein
the capturing hole includes a filter for adsorbing the mist.

7. A liquid ejecting head according to claim 5, further comprising
a suctioning unit connected to the capturing hole for suctioning the air between the head main body and the rotating member.

8. A liquid ejecting head according to claim 5, wherein
the head main body includes an air introduction hole provided between the capturing holes and the nozzles to supply the air to a space between the head main body and the rotating member.

9. A printing apparatus including a print head for printing visible information by ejecting ink droplets onto a printing surface of a printing subject rotationally driven by a rotation drive unit, the print head comprising:
a head main body having nozzles facing the printing surface, and ejecting the ink droplets from the nozzles; and
a mist capturing unit capturing mist of the ink droplets from the nozzles, wherein
the mist capturing unit is formed such that a passage, through which air flows in a predetermined direction over the printing surface while the printing subject is driven to rotate, is formed narrower than a distance between the nozzles and the printing surface.
